(19) United States
(12) Patent Application Publication
(10) Pub. No.: US 2011/0142522 A1
(43) Pub. Date: Jun. 16, 2011

(54) Typing to generate electricity

(76) Inventor: Bert Yeh, Cupertino, CA (US)

(21) Appl. No.: 12/653,352

(22) Filed: Dec. 11, 2009

(51) Int. Cl. B41J 5/00

(52) U.S. Cl. 400/474

(57) ABSTRACT

This invention proposes to use the typing force to generate electricity. Electromagnetic devices are placed under the keys of a keyboard. When a key is pressed, the electromagnetic devices are driven so that the magnets and the coils or the coils and cores have relative movement to generate the electricity. When the key is released, the force stored in the spring or between the magnets and the cores or both drives the key, the magnets, and the coils or the cores and coils back to their positions so that the magnets and the coils or the coils and cores have relative movement to generate the electricity. Any number of keys may share any number of electromagnetic devices. For the wireless keyboard, with the generation of the electrical currents when the typing keys are operated with pressing down or raising up movements, the batteries are no longer required and can be eliminated.

### BACKGROUND OF THE INVENTION

The present invention relates generally to mechanical structures and electrical circuit configurations of keyboard devices. More particularly, this invention relates to mechanical structures and electrical circuit configurations of keyboard devices for applying the typing force to generate electricity when the keyboard user types the keys.

FIG. 1 is a cross sectional view that shows a conceptual model of a key 10 of a conventional keyboard. The key 10 has a key spring 20 or the like under the key. FIG. 2 shows the key 10 is pressed down and contact an electronic circuit board 120 to set or to send a signal to the controller or the CPU to indicate which key is pressed. Meanwhile, an amount of energy is stored in the key spring 20 that is pressed down as shown in FIG. 2. When the key 10 is released, the energy stored in the key spring 20 is released to push the key 10 back to its position. When the keyboard users, especially the game players, type the keys, the force they press the keys is usually more than what is required for typing by pushing down the key. The conventional keyboards have no mechanical structures and electrical circuits to effectively take advantage of the excessive force.

Therefore, a need still exists in the art of designing and manufacturing the wireless keyboards to provide new and improved mechanical structures and electrical circuits configurations such that the limitations and inconveniences of requiring batteries to operate the wireless keyboards can be resolved.

### BRIEF SUMMARY OF THE INVENTION

An aspect of the present invention is to provide a new and improved keyboard to apply the typing force to generate electricity. Electromagnetic devices are placed under the keys of a keyboard. When a key is pressed, the electromagnetic devices are driven so that the magnets and the coils or the coils and cores have relative movement to generate the electricity. When the key is released, the force stored in the spring or between the magnets and the cores or both drives the key, the magnets, and the coils or the cores and coils back to their positions so that the magnets and the coils or the coils and cores have relative movement to generate the electricity. The number of keys may be flexibly adjusted to share adjustable number of electromagnetic devices. With the self generated electrical energy to transmit the keyboard signals from the wireless keyboard, the batteries can be eliminated.

### BRIEF DESCRIPTION OF THE SEVERAL VIEWS OF THE DRAWING

FIGS. 1 and 2 are cross sectional views of a key in a conventional keyboard to illustrate the operation of the key of the conventional keyboard when the key is operated in a released and then in a pressed-down condition respectively.

FIGS. 3A and 3B show the conceptual model of an electromagnetic device composing of a magnet and a coil where the electricity is generated if the magnet and the coil have relative movement. The former shows that the coil is placed around the magnet and the latter shows that the magnet is placed around the coil.

FIGS. 4A and 4B show the conceptual model of an electromagnetic device composing of a magnet and a core wound by a coil where the electricity is generated if the magnet and the core have relative movement. The former shows that the core and coil is placed around the magnet and the latter shows that the magnet is placed around the core and coil.

FIGS. 5 and 6 show the key of FIGS. 1 and 2 is combined with the coil-magnet device shown in FIG. 3A where the magnet is pressed in FIG. 6 and is pushed back in FIG. 5 to generate the electricity.

FIGS. 7 and 8 show the key of FIGS. 1 and 2 is combined with the coil-magnet device shown in FIG. 3A where the coil is pressed in FIG. 8 and is pushed back in FIG. 7 to generate the electricity.

FIGS. 9 and 10 show the key of FIGS. 1 and 2 is combined with the electromagnetic device shown in FIG. 4A where the magnet is pressed in FIG. 10 and is pushed back in FIG. 9 to generate the electricity.

FIGS. 11 and 12 show the key of FIGS. 1 and 2 is combined with the electromagnetic device shown in FIG. 4A where the coil and core is pressed in FIG. 12 and is pushed back in FIG. 11 to generate the electricity.

FIG. 13˜16 show the side views of a model that by applying levers, many keys share one electromagnetic device to generate electricity.

FIG. 17 shows the top view of a model that by implementing rotating rods, many keys share one electromagnetic device to generate electricity.

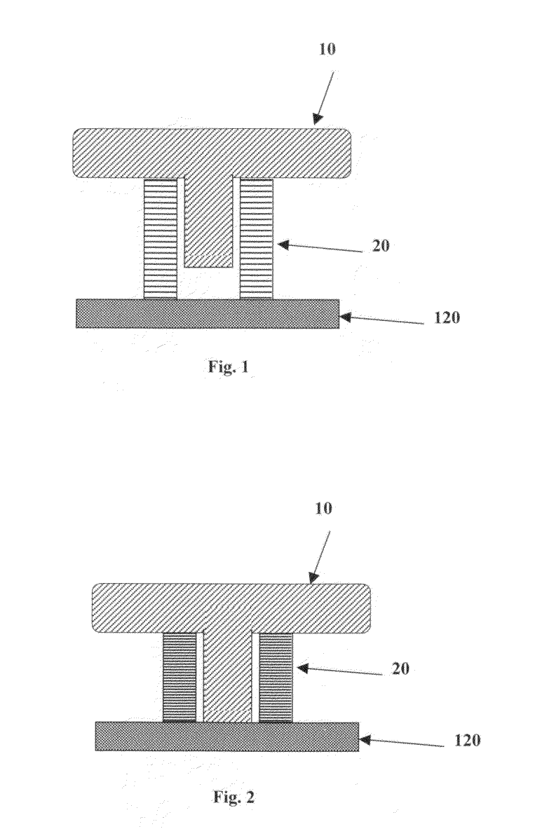

### DETAILED DESCRIPTION OF THE INVENTION

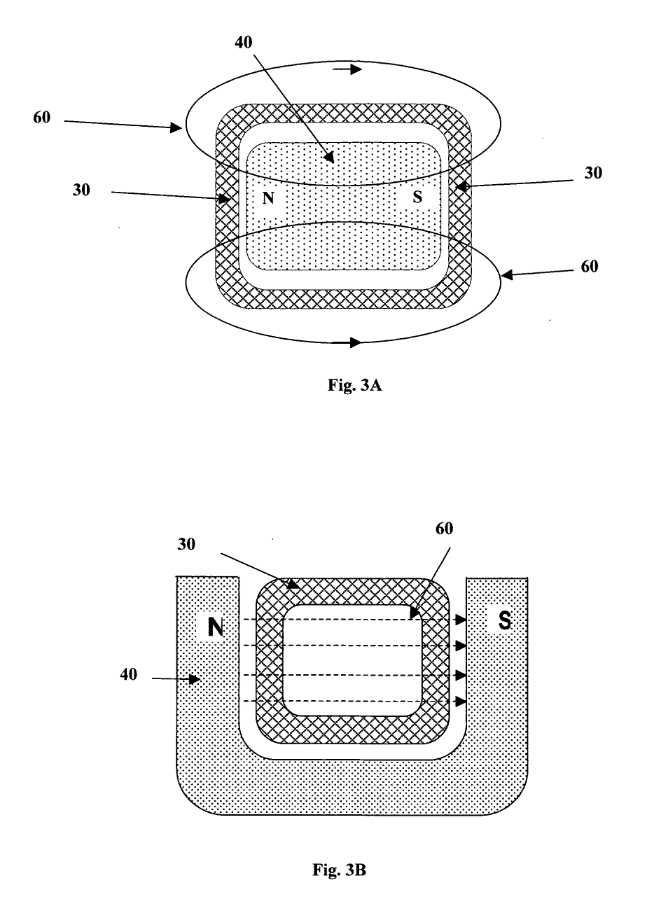

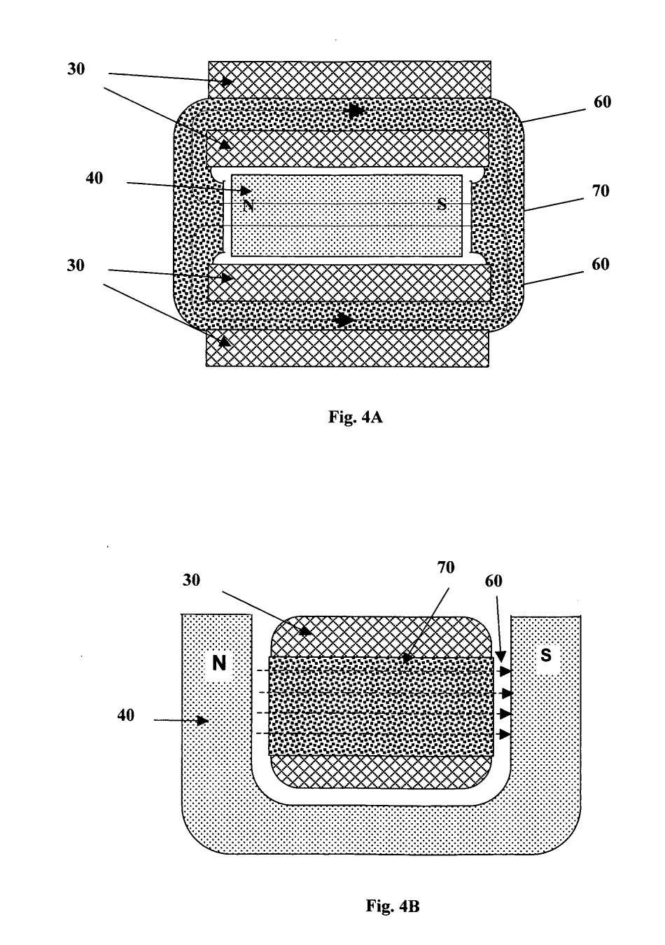

FIG. 3A shows a simple electromagnetic device that can generate electricity. The magnet 40 has magnetic flux 60. The coil 30 is wound and is placed around the magnet 40. When the coil 30 has relative movement with the magnet 40, the coil 30 “cuts” the flux 60. Then, the electrical current is generated in the coil 30. FIG. 3B shows an equivalent device where the magnet 40 is placed around the coil 30. Alternatively, as FIG. 4A shows, the magnetic core 70 is wound with the coil 30 and is placed around the magnet 40. Most magnetic flux 60 of the magnet 40 is kept in the core 70. If the core 70 and coil 30 has relative movement with the magnet 40, the flux 60 in the core 70 will be changed. Then, the electrical current is generated in the coil 30. FIG. 4B shows an equivalent device where the magnet 40 is placed around the coil 30 and core 70.

Therefore, linking the device shown in FIG. 3A or 3B or in FIG. 4A or 4B or the equivalent to the keys of the keyboard, the typing force pressed by the keyboard users can be used to move the magnet 40, the coil 30, or the coil 30 and core 70 to generate the electricity.

The keyboards need electricity only when the users are typing. The electricity is generated when the users are typing. Therefore, the batteries can be eliminated for the wireless keyboards.

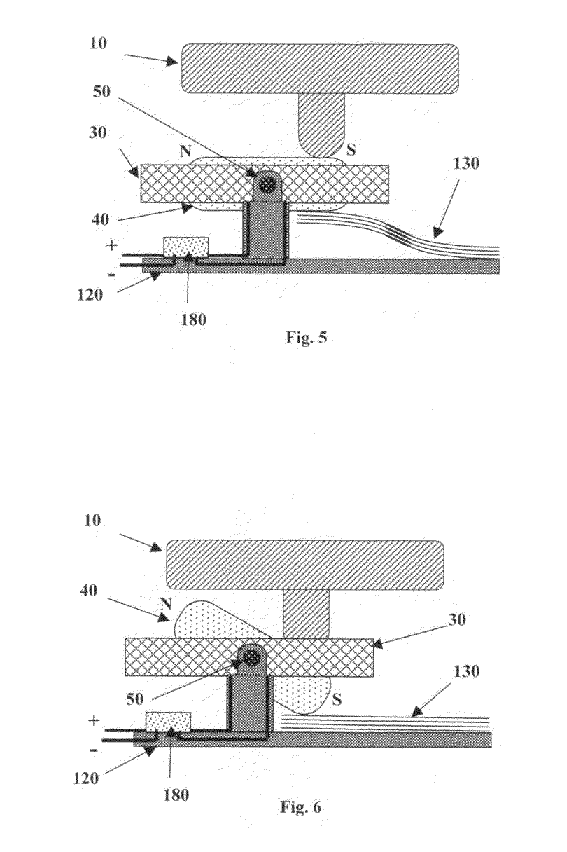

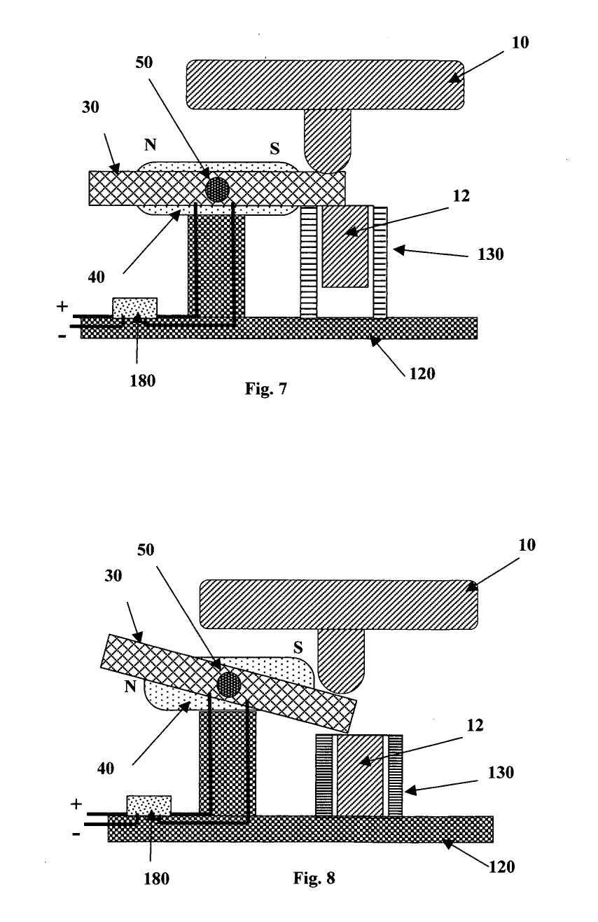

FIGS. 5 and 6 illustrate a simple model of this invention where FIG. 5 depicts that the key 10 is not pressed and FIG. 6 shows that the key 10 is pressed down. In this case, the magnet-coil device illustrated in FIG. 3A is implemented in the key. One end of the driving spring 130 and the coil 30 are fixed to the electronic circuit board 120. When the key 10 is pressed, the magnet 40 is pressed to rotate with the rotating axis 50, the driving spring 130 is pressed, and a signal is set or sent to the controller or to the CPU to indicate which key is pressed as FIG. 6 shows. So, the coil 30 “cuts” the flux of the magnet 40 and the electricity is generated in the coil 30. When the key 10 is released, the driving spring 130 pushes the magnet 40 and the key 10 back to their positions as FIG. 5 shows. The coil 30 “cuts” the flux of the magnet 40, again, and the electricity is generated in the coil 30. The directions of the current generated in the pressing process and in the releasing process are reverse. The two ends of the wire of the coil 30 are connected to a rectifier 180 to convert the current to be DC to be fed to the power supply of the keyboard.

FIGS. 7 and 8 are cross sectional views for showing a key of a keyboard of this invention wherein the magnet 40 is fixed. When the key 10 is pressed, the coil 30 is pressed to rotate with the rotating axis 50, the driving spring 130 is pressed, and the key extension 12 is pressed down to touch the electronic circuit board 120 to set or to send a signal to the controller or to the CPU to indicate which key is pressed as FIG. 8 shows. The electricity is generated in the coil 30. When the key 10 is released, the driving spring 130 pushes the coil 30 and the key 10 back to their original positions. The electricity is generated in the coil 30 in the reverse direction. The two ends of the wire of the coil 30 are connected to a rectifier 180 to convert the current to be DC to be fed to the power supply of the keyboard.

In the above examples, the electrical currents are generated when there is a conductive coil moves across magnetic flux according to the operational principle of the magnet-coil device illustrated in FIG. 3A. The electromagnetic device can be replaced with that illustrated in FIG. 3B to work equivalently.

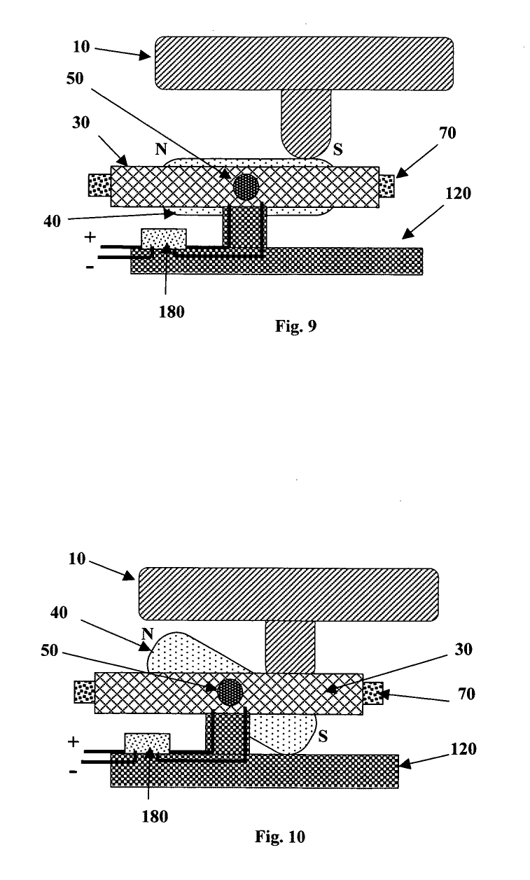

The magnet-coil device used in the above cases can be replaced with the magnet-coil device illustrated in FIG. 4A where the core 70 is wound with the coil 30. FIGS. 9 and 10 depict the dual model of the model shown in FIGS. 5 and 6 where the coil 30 and core 70 is fixed to the electronic circuit board 120. When the key 10 is pressed, the magnet 40 is pressed to rotate with the rotating axis 50 as shown in FIG. 10. A signal indicating which key is pressed is set or sent to the controller or to the CPU. The flux 60 in the core 70 is changed. That generates electricity in the coil 30. Since the magnet 40 and the core 70 form a magnet circuit, the magnet 40 and the core 70 attract each other. So, when the key 10 is released, the magnet 40 is attracted to return back to its original position and to push the key 10 back as FIG. 9 shows. Since the flux 60 in the core 70 is changed, again, the electricity is generated in the reverse direction. Springs may be needed to push the magnet 40 back if the magnetic attraction force is too low. The two ends of the wire of the coil 30 are connected to a rectifier 180 to convert the current to be DC to be fed to the power supply of the keyboard.

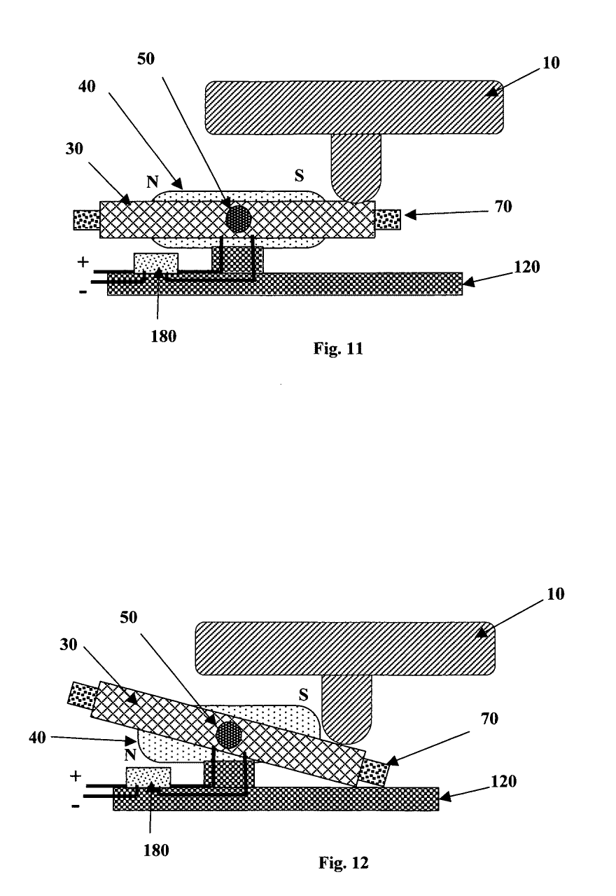

FIGS. 11 and 12 depict the dual of the model shown in FIGS. 7 and 8 where the magnet 40 is fixed to the electronic circuit board 120. When the key 10 is pressed, the coil 30 and core 70 is pressed to rotate with the rotating axis 50 as shown in FIG. 12. A signal indicating which key is pressed is sent to the controller or to the CPU. The flux 60 in the core 70 is changed and the electricity is generated in the coil 30. When the key 10 is released, the coil 30 and core 70 is attracted to return back to its original position and to push the key 10 back to the original position as FIG. 11 shows. The flux 60 in the core 70 is changed and the electricity is generated in the reverse direction. Springs may be needed to push the coil 30 and the core 70 back if the magnetic attraction force is too low. The two ends of the wire of the coil 30 are connected to a rectifier 180 to convert the current to be DC to be fed to the power supply of the keyboard.

In the above examples, the electrical currents are generated when there is a conductive coil moves across magnetic flux according to the operational principle of the electromagnetic device illustrated in FIG. 4A. The electromagnetic device can be replaced with that illustrated in FIG. 4B to work equivalently.

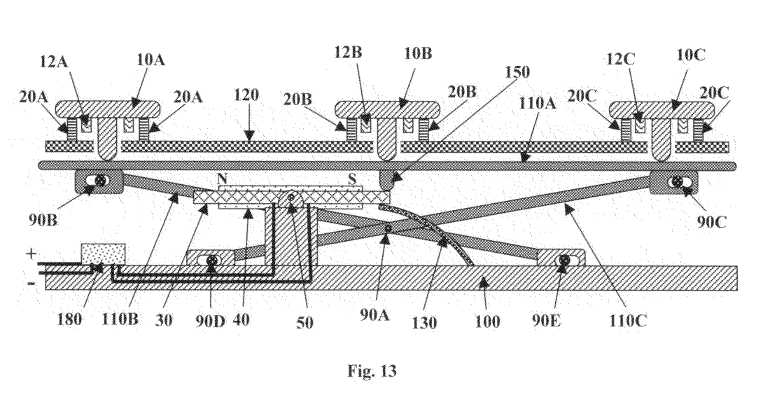

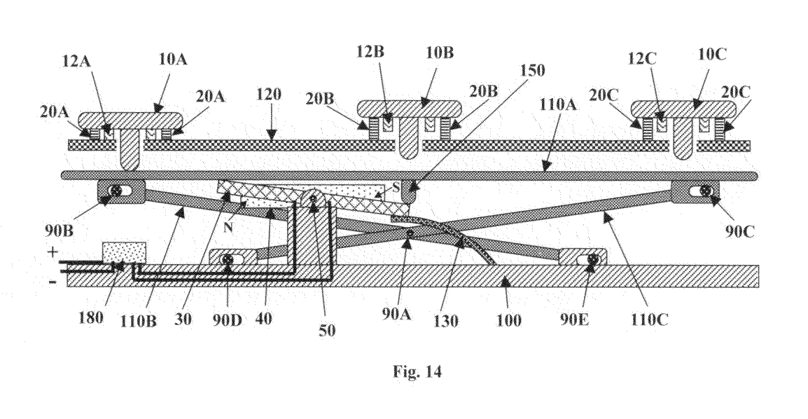

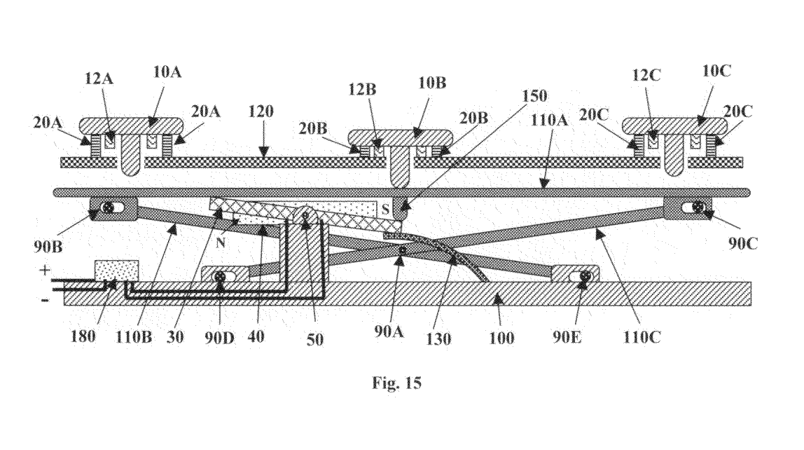

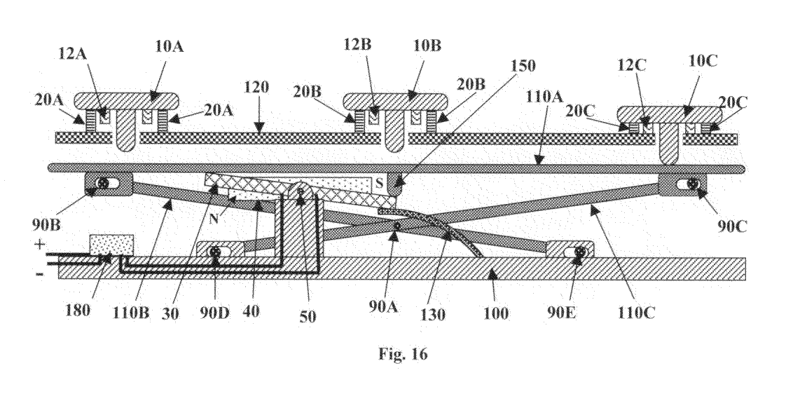

A configuration of utilizing one electromagnetic device for each key may increase the production cost of the keyboard thus causing the keyboard to be expensive. FIGS. 13 to 16 illustrate a keyboard of this invention with mechanical structures implemented with levers where multiple keys share an electromagnetic device to generate electricity. Three keys are illustrated in FIGS. 13 and 14 for explanation. The keys 10A, 10B, and 10C have key springs 20A, 20B, or 20C, respectively, to keep the keys at the higher position when the keys are not pressed as shown FIG. 13. The levers 110B and 110C can rotate with the joint 90A as the axis. The levers 110B and 110C are connected to the substrate 100 at the joints 90E and 90D, respectively, and are connected to the top plate 110A at the joints 90B and 90C, respectively. The levers 110B and 110C can slide laterally a little bit at these four joints, 90B, 90E, 90D and 90C, respectively. Assume that the magnet-coil device illustrated in FIG. 3A is used and the magnet 40 is fixed. When the keys are not pressed, the driving spring 130 pushes the coil 30, the top plate 110A, and the joint 90A to the up most positions and the four joints 90B, 90E, 90D and 90C, of the levers 110B and 110C slide to the inner most positions as shown in FIG. 13. When the left key 10A is pressed as FIG. 14 shows, the key spring 20A is pressed, the key extension 12A touches the electronic circuit board 120 to set or to send a signal to the controller or to the CPU to indicate which key is pressed and the left end of the top plate 110A is pressed. The levers 110B and 110C are pressed down and rotate with the joint 90A as the axis. So, the two ends of the lever 110B slides to the opposite directions at the joints 90B and 90E and the two ends of the lever 110C slides to the opposite directions at the joints 90C and 90D. Hence, the whole top plate 110A is pressed down and its presser 150 presses the coil 30 down. The coil 30 rotates with the rotating axis 50 and presses and squeezes the driving spring 130. Since the magnet 40 is fixed, the coil 30 and the magnet 40 have relative movement. The electricity is generated in the coil 30. When the left key 10A is released, the driving spring 130 pushes the coil 30, the top plate 110A, the levers 110B and 110C, and the key 10A back to their positions as shown in FIG. 13. Electricity is generated in the coil 30, again, but, with opposite direction. FIGS. 15 and 16 show that, when the middle key 10B and the right key 10C are pressed, respectively, the key extensions 12B and 12C, respectively, touches the electronic circuit board 120 to set or to send a signal to the controller or to the CPU to indicate which key is pressed. Meanwhile, the top plate 110A, the levers 110B and 110C, the coil 30, and the driving spring 130 are pressed down the same way as when the key 10A is pressed. So, the electricity is generated in the coil 30. When the keys 10B and 10C are released, respectively, the driving spring 130 pushes the coil 30, the top plate 110A, the levers 110B and 110C, and the keys 10B and 10C back to their positions, respectively, as shown in FIG. 13. Electricity is generated in the coil 30, again, but, with opposite direction. The two ends of the wire of the coil 30 are connected to a rectifier 180 to convert the current to be DC to be fed to the power supply of the keyboard. Equivalently, the case that the coil 30 is fixed and the magnet 40 is pressed and released works the same way.

In the above example, the electrical currents are generated when there is a conductive coil moves across magnetic flux according to the operational principle of the magnet-coil device illustrated in FIG. 3A. The electromagnetic device can be replaced with that illustrated in FIG. 3B, 4A, or 4B. Either the magnet 40 or the coil 30 or the coil 30 and core 70 may be structured as a fixed component and the other component of the electromagnetic device is pressed and released. These electromagnetic devices are implemented to generated electric currents according to the same principle.

There are many different designs. For examples, the electronic circuit board 120 may be built on the top plate 110A and there may be any number of driving springs 130. Another example is that a number of keys share few electromagnetic devices. This is good when one electromagnetic device is too big for thin or compact keyboards. The big one is replaced by few smaller ones to fit in the thin or compact keyboard.

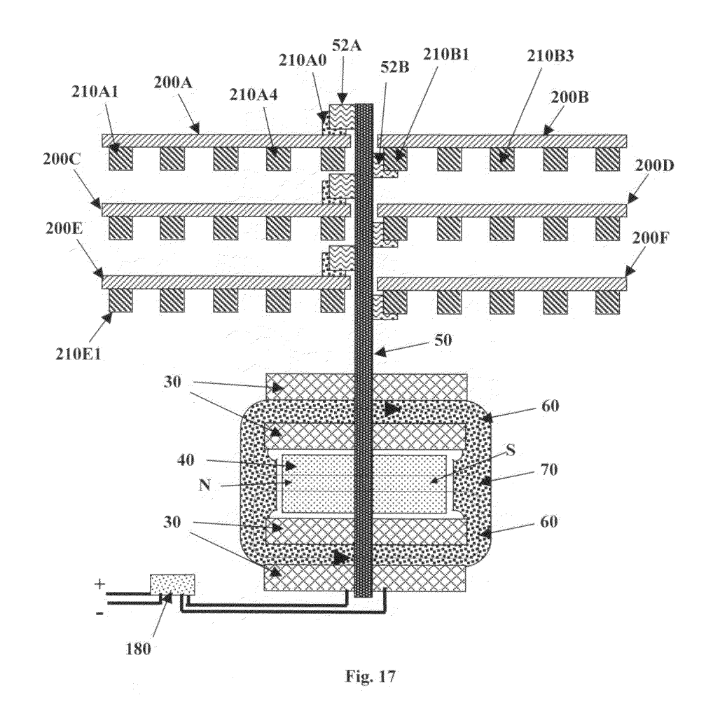

There are also many different constructions and forms of the levers. All kinds of mechanical devices that can transfer the typing force to the electromagnetic devices will work. FIG. 17 illustrates another example that, using rotating rods, multiple keys share an electromagnetic device to generate electricity. In FIG. 17, the keys and the electronic circuit board are not shown to keep the drawing neat. The keys and the electronic circuit board are similar with that shown in FIGS. 13˜16. In this example, 30 keys are arranged into three rows and each row is divided into two wind rods. The wing rods 200A, 200B, . . . 200F are fixed and can rotate with their axis as the rotating axis. Each wing rod 200X has pressing pins 210X1, 210X2, . . . 210X5 where X represents which wing rod. Each key is associated with one pressing pin 210XY, where Y represents which pressing pin of the wing rod 200X. When a key is pressed, a signal indicating which key is pressed is set or is sent out and the associated pressing pin 210XY is pressed. Hence, the wing rod 200X rotates. In FIG. 17, the electromagnetic device illustrated in FIG. 4A is assumed. Either the magnet 40 is fixed to the substrate or the case and the coil 30 and core 70 is fixed to the rotating axis 50 or the coil 30 and core 70 is fixed to the substrate or the case and the magnet 40 is fixed to the rotating axis 50. The rotating axis 50 can rotate and has a rotating pin 52X for each wing rod 200X where X represents which wind rod. So, when a key is pressed, the associated pressing pin 210XY is pressed and the wing rod 200X rotates. Then, either the pressing pin 210X0 where X is A, C, or E or the pressing pin 210X1 where X is B, D, or F presses the rotating pin 52X. Hence, the rotating axis 50 rotates and the magnet 40 and the core 70 have relative movement. Consequently, the electricity is generated in the coil 30. When the key is released, the magnetic force between the magnet 40 and the core 70 will pull the device fixed to the rotating axis 50 to rotate back to its original position. That not only generates electricity but also rotates the rotating axis 50. So, the rotating pin 52X pushes the associated pressing pin 210X0 where X is A, C, or E or 210X1 where X is B, D, or F to rotate the associated wing rod 200X. Consequently, the associated pressing pin 210XY pushes the key back to its position. The two ends of the wire of the coil 30 are connected to a rectifier 180 to convert the current to be DC to be fed to the power supply of the keyboard. Springs may be implemented to push the key and the magnet 40 or the coil 30 and core 70 back to their positions and to generate electricity if the magnetic attraction force is too low.

The electromagnetic device in this example can be replaced by the magnet-coil device illustrated in FIG. 3A, 3B, or 4B. Also, either the magnet 40 is fixed to the substrate or the case and the coil 30 or the coil 30 and core 70 is fixed to the rotating axis 50 or the coil 30 or the coil 30 and core 70 is fixed to the substrate or the case and the magnet 40 is fixed to the rotating axis 50. They work equivalently.

The above embodiments are implemented with one mechanical device and one electromagnetic device. However, a keyboard may comprise multiple mechanical devices or multiple electromagnetic devices or both. Each mechanical device may be associated with any number of keys and any number of electromagnetic devices. So that each electromagnetic device or each mechanical device or both are smaller. The configuration has advantages for thin or compact keyboards that have small space for the electromagnetic devices and the mechanical devices. They function the same way as that explained for the above embodiments.

The electricity generated when the user is typing is rectified and is fed to be the power supply of the keyboard. The keyboard does not need power when the keyboard user does not type. The keyboard needs power only when the user is typing. In the other words, the keyboard needs power only when the electricity is being generated. Therefore, this invention provides new and improved configurations and device structures for the wireless keyboard because the batteries can be eliminated.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. A keyboard comprising:
a plurality of typing keys linked to a mechanical structure for restoring each of the typing keys from a pressed down position to a natural position;
an electronic circuit board for contacting an extension of each of the typing keys as part of the mechanical structure when one of the typing keys is in the pressed down position for generating signals for each of the typing keys;
an electromagnetic device for generating an electrical current from a movement of each of the typing keys for providing an electrical energy to the electronic circuit board.

2. The keyboard of claim 1 wherein
the electromagnetic device further includes one or more pairs of coil and magnet and said electromagnetic device is mechanically linked to the keys for generating a relative movement between the coil and the magnet for generating the electric current when one of the keys is pressed down and then restored to the natural position.

3. The keyboard of claim 1 wherein
the electromagnetic device further includes one or more pairs of magnet and magnetic core wrapped with coil and said electromagnetic device is mechanically linked to the keys for generating a relative movement between the core and the magnet for generating the electric current when one of the keys is pressed down and then restored to the natural position.

4. The keyboard of claim 1 further comprising:
a rectifier for rectifying the current generated by the electromagnetic device during a key movement in pressing down and a reverse key movement when the key is restored to the natural position.

5. The keyboard of claim 1 wherein:
the mechanical structure further includes layers for mechanically linking to a plurality of said typing keys for transferring a mechanical force from the typing keys to the electromagnetic device when each of the keys is pressed down and then restoring to the natural position for generating the electric current.

6. The keyboard of claim 1 wherein the mechanical structure further includes rotating rods coupled to a plurality of said typing keys for transferring a mechanical force from the typing keys to the electromagnetic device when each of the keys is pressed down and then restoring to the natural position for generating the electric current.

7. The keyboard of claim 1 wherein the mechanical structure further includes one or more springs for storing the energy when each of the typing keys is pressed down and for restoring said typing key back to the natural position and generating electricity when said typing key is released.

8. The keyboard of claim 1 wherein: said keyboard is a wireless keyboard and the electronic circuit board receives the electric current from the electromagnetic device for generating a wireless signal for each of the keys when it is pressed down and when it is released to contact the electronic circuit board.
